(19) United States
(12) Patent Application Publication
(10) Pub. No.: US 2026/0359388 A1
(43) Pub. Date: Nov. 12, 2026

(54) PROCESSING STATE ESTIMATION APPARATUS, AND PROCESSING STATE ESTIMATION METHOD

(71) Applicant: Panasonic Intellectual Property Management Co., Ltd., Osaka (JP)

(72) Inventor: NAOKI NOJIRI, Osaka (JP)

(21) Appl. No.: 19/659,971

(22) Filed: Apr. 27, 2026

(30) Foreign Application Priority Data
May 8, 2025 (JP) 2025-077985

(51) Int. Cl. G06F 17/16

(52) U.S. Cl. CPC G06F 17/16

(57) ABSTRACT

A storage of a processing state estimation apparatus stores a plurality of processing state values defining a processing state of a processing machine, and a plurality of pieces of reference data each corresponding to a different one of combinations of the plurality of processing state values. The processor acquires time-series measurement data measured during processing, determines at least one piece of reference data, and determines a plurality of difference vectors based on differences between the time-series measurement data and the at least one piece of reference data at a plurality of measurement points temporally separated from each other. The processor determines a Euclidean distance between the time-series measurement data and the at least one piece of reference data in the oblique coordinate system based on the plurality of difference vectors, and estimates the processing state based on the determined Euclidean distance. The angle between the basis vectors forming the plurality of difference vectors is set to vary depending on the time interval between the plurality of measurement points.

### BACKGROUND

### 1. Technical Field

The present disclosure relates to a processing state estimation apparatus and a processing state estimation method.

### 2. Description of the Related Art

PTL 1 and PTL 2 disclose a technique of acquiring measurement data indicating a measurement result of a processing load applied to a processing machine and estimating a processing state. The processing state estimation apparatus of PTL 1 determines a similarity between reference data corresponding to a combination of a plurality of parameters defining a processing state of a processing machine and measurement data indicating a measurement result of a processing load, and estimates the processing state. A processing state estimation apparatus of PTL 2 generates reference data regarding a processing load based on a length definition of a plurality of areas obtained by dividing a punched contour with respect to the processing state estimation apparatus of PTL 1, determines a similarity with measurement data indicating a measurement result of the processing load, and estimates a processing state.

### CITATION LIST

### Patent Literature

PTL 1: International Publication No. 2023/162305
PTL 2: International Publication No. 2023/162306

### SUMMARY

A processing state estimation apparatus according to an aspect of the present disclosure includes:
a storage; and
a processor,
wherein the storage is configured to store
   a plurality of processing state values defining a processing state of a processing machine, and
   a plurality of pieces of reference data each corresponding to a different one of combinations of the plurality of processing state values,
the processor is configured to
   acquire time-series measurement data measured during processing by the processing machine,
   determine at least one piece of reference data from among the plurality of pieces of reference data,
   determine a plurality of difference vectors based on differences between the time-series measurement data and the at least one piece of reference data at a plurality of measurement points temporally separated from each other,
   determine a Euclidean distance between the time-series measurement data and the at least one piece of reference data in an oblique coordinate system based on the plurality of difference vectors, and
   estimate the processing state based on the determined Euclidean distance,
wherein an angle between basis vectors forming the plurality of difference vectors is set to vary depending on a time interval between the plurality of measurement points.

A processing state estimation method according to an aspect of the present disclosure includes:
acquiring time-series measurement data measured during processing by the processing machine;
determining at least one piece of reference data from among a plurality of pieces of reference data, each of which corresponds to a different one of combinations of a plurality of processing state values that define a processing state of the processing machine;
determining a plurality of difference vectors based on differences between the time-series measurement data and the at least one piece of reference data at a plurality of measurement points temporally separated from each other;
acquiring setting data relating to an angle formed between basis vectors that constitute the plurality of difference vectors;
determining a Euclidean distance between the time-series measurement data and the at least one piece of reference data in an oblique coordinate system based on the plurality of difference vectors, and
estimating the processing state based on the determined Euclidean distance,
wherein an angle between basis vectors forming the plurality of difference vectors is set to vary depending on a time interval between the plurality of measurement points.

### BRIEF DESCRIPTION OF THE DRAWINGS

FIG. 1 is a block diagram illustrating a configuration example of a processing state estimation apparatus according to an exemplary embodiment;

FIG. 2 is a schematic sectional view illustrating a press machine equipped with a load sensor and a distance sensor illustrated in FIG. 1;

FIG. 3 is a schematic graph indicating an example of a measured waveform obtained by the load sensor and the distance sensor illustrated in FIG. 1;

FIG. 4 is a flowchart indicating a procedure of the processing state estimation processing executed by a CPU of the processing state estimation apparatus in FIG. 1;

FIG. 5 is a diagram for explaining a processing waveform extracted from a measured waveform;

FIG. 6 is a diagram illustrating a table of an example of reference data illustrated in FIG. 1;

FIG. 7A is a diagram for describing a Euclidean distance due to differences in reference waveforms;

FIG. 7B is a diagram for describing a Euclidean distance due to differences in reference waveforms;

FIG. 7C is a diagram for describing a Euclidean distance due to differences in reference waveforms;

FIG. 7D is a diagram for describing a Euclidean distance due to differences in reference waveforms;

FIG. 8A is a diagram for describing a Euclidean distance due to differences in reference waveforms;

FIG. 8B is a diagram for describing a Euclidean distance due to differences in reference waveforms;

FIG. 9A is a diagram illustrating an example in which a vector is represented in an orthonormal coordinate system;

FIG. 9B is a diagram illustrating an example in which a vector is represented in an oblique coordinate system, and is a diagram for describing a contravariant vector;

FIG. 9C is a diagram illustrating an example in which a vector is represented in an oblique coordinate system, and is a diagram for describing a covariant vector;

FIG. 10 is a flowchart illustrating a procedure of Euclidean distance calculation processing between a processing waveform and a reference waveform;

FIG. 11 is a diagram illustrating processing of calculating a difference waveform between a processing waveform and a reference waveform as a covariant vector;

FIG. 12A is a graph showing a plurality of load waveforms obtained by changing a clearance in a punching simulation;

FIG. 12B is a graph showing a plurality of load waveforms obtained by changing the punch wear amount in the punching simulation;

FIG. 12C is a graph showing a plurality of load waveforms obtained by changing the die wear amount in the punching simulation;

FIG. 12D is a graph showing a plurality of load waveforms obtained by changing the workpiece thickness in the punching simulation;

FIG. 13A is a diagram illustrating an example of a preset screen;

FIG. 13B is a diagram illustrating an example of a preset screen;

FIG. 13C is a diagram illustrating an example of a preset screen;

FIG. 14A is a diagram illustrating an example in which a vector is represented in an orthonormal coordinate system;

FIG. 14B is a diagram illustrating an example in which a vector is represented in an oblique coordinate system, and is a diagram for describing a contravariant vector;

FIG. 14C is a diagram illustrating an example in which a vector is represented in an oblique coordinate system, and is a diagram for describing a covariant vector;

FIG. 15 is a diagram illustrating processing of calculating a difference waveform between a processing waveform and a reference waveform as a contravariant vector; and

FIG. 16 is a flowchart illustrating a procedure of Euclidean distance calculation processing between a processing waveform and a reference waveform.

### DETAILED DESCRIPTIONS

An object of the present disclosure is to provide a processing state estimation apparatus and a processing state estimation method for estimating a processing state by a processing machine more accurately than in the related art.

### (Findings Underlying the Present Disclosure)

The present inventors have repeatedly conducted studies for estimating a processing state in cycle processing in which the same processing is repeated, particularly processing by a processing machine, and as a result, have obtained the following findings. Here, the “processing state” indicates parameters that define a processing state in the present disclosure, and includes, for example, at least one of the wear amount of the tool, the clearance, the thickness of the workpiece, or the hardness of the workpiece. The “processing state value” is a value indicating a processing state.

The wear amount of the tool includes a punch wear amount and a die wear amount. The punch wear amount and the die wear amount are examples of a punch wear parameter that is an index indicating a degree of wear of the punch and a die wear parameter that is an index indicating a degree of wear of the die, respectively. The wear amount of the tool such as the punch wear amount and the die wear amount is represented by, for example, a dimensional change from the dimension of the tool at the time when the tool is newly manufactured or repolished. Alternatively, the wear amount of the tool may be represented by a dimensional change from a design value of the tool. The wear amount of the tool may be represented by the amount of change such as a shape change, a volume change, or a mass change. In addition, the wear amount of the tool may be represented by a radius of an arc in a case where the wear is approximated as the arc.

The clearance is a gap between the die and the punch. For example, the clearance is a gap between the die and the punch when a punching hole is formed in the workpiece. The clearance may be represented by a ratio of the gap between the die and the punch and the thickness of the workpiece.

The workpiece thickness is the thickness of the workpiece, and is measured as a length by, for example, a micrometer, a laser displacement meter, or the like, and the unit thereof is, for example, μm.

The workpiece hardness is a value indicating the hardness of the workpiece, and is measured as Vickers hardness by, for example, a Vickers hardness test, and the unit thereof is, for example, HV.

In processing by a processing machine, a processing state appears in a specific operation performed using a tool. For example, it is known that the processing state appears in measurement data obtained by sensing a processing point.

For example, in press forming, a load applied to a tool corresponds to a processing point. Therefore, it is conceivable to estimate the processing state value from the load waveform obtained by sensing the load applied to the tool.

Since the load applied to the punch or the workpiece during processing depends on parameters such as the punch wear amount, the die wear amount, the clearance, the thickness of the workpiece, and the hardness of the workpiece, it is conceivable to estimate these parameters from the load waveform obtained during processing. For example, if the state of the tool can be estimated from the change in the inclination of the waveform, it is possible to know a desired maintenance timing of the tool in the processing machine that performs the cycle processing. If maintenance is performed at a desired timing, a situation in which a workpiece is processed with a wom tool and a large number of defective products are manufactured can be prevented, and productivity can be improved.

In the processing machine that performs cycle processing, there is an advantage that an estimation result of the processing state for immediately preceding punching is used for the estimation of the processing state. One of the reasons is that values of the clearance, the punch wear amount, the die wear amount, and the like usually do not change greatly from values in the immediately preceding punching. By performing estimation under the condition that there is no significant change from the immediately preceding estimation result, estimation accuracy can be improved.

Regarding the state of the workpiece, if the processing state can be estimated in-line, for example, for each processing cycle by the processing machine, it is not necessary to measure the state of the workpiece using another measuring machine. The workpiece state estimated in this manner can be used not only for traceability but also for process management by observing these trends of the state of the workpiece.

Furthermore, when the workpiece state can be estimated for each processing cycle, a variation of the workpiece state within a lot and between lots can be managed or displayed as a trend, and thus can be used for state management of the workpiece input to the press machine, process management, and process improvement by analyzing the state management and the process management.

The load waveform used in the estimation of the processing state is obtained for each processing cycle. Here, the processing cycle is a period from the start of lowering of the punch until the punch rises and stops after punching. The waveform obtained in the processing cycle includes a period during which processing is actually performed on the workpiece from the start time point (for example, when the punch comes into contact with the workpiece) to the end time point (for example, when the punch no longer comes into contact with the workpiece) of punching.

In the related art, the processing state is estimated by collectively calculating the similarity within this range. Here, the similarity is an index indicating a degree of similarity between two waveforms. In the related art, for example, a load waveform obtained by measurement is compared with a reference waveform set in advance and stored in a processing machine to calculate similarity between the load waveform and the reference waveform. The similarity can be obtained by, for example, a Euclidean distance between two waveforms. For example, the shorter the Euclidean distance between the load waveform and the reference waveform, the greater the similarity between the load waveform and the reference waveform.

However, the load waveform obtained by the measurement during the cycle processing in which the same processing is repeated includes measurement noise. In the case of calculating the Euclidean distance between the load waveform and the reference waveform in the period from the start time point to the end time point of punching, if the Euclidean distance is collectively calculated without considering the measurement noise included in the load waveform, the Euclidean distance may be calculated to be long. In addition, when the Euclidean distance is calculated in this way, there is a possibility that the variation in the Euclidean distance increases for each cycle.

As a result of intensive studies on this point, the inventor has obtained a concept of using an oblique coordinate space when calculating a Euclidean distance between a load waveform obtained by sensing a processing point and a reference waveform. In particular, the inventor has obtained a concept of using an oblique coordinate space in which a plurality of measurement points temporally separated from each other are set as coordinate values of a vector and coordinate axes forming the vector are oblique. It has been found that the accuracy of estimation is improved when the similarity is calculated in this manner and the processing state is estimated based on the calculation result. In addition, it has been found that by changing the angle between the oblique coordinate axes according to the time interval of the plurality of measurement points, the similarity can be calculated in consideration of both the influence of measurement noise and the characteristics of the processing state of the processing machine. The inventors have found that, by calculating the similarity between the load waveform obtained by sensing the processing point and the reference waveform based on these findings, the influence of measurement noise can be reduced and the processing state can be estimated more accurately in consideration of the characteristics of the processing state of the processing machine, leading to the present disclosure.

Hereinafter, exemplary embodiments of the present disclosure will be described in detail with reference to the drawings appropriately. However, unnecessarily detailed description may be omitted. For example, detailed descriptions of already well-known matters and duplicated descriptions of substantially the same configuration may be omitted. This is to avoid an unnecessarily redundant description in the following description and to facilitate understanding of those skilled in the art. The inventors provide the attached drawings and the following description for those skilled in the art to fully understand the present disclosure, and thus do not intend that the attached drawings and the following description limit the subject matter described in the scope of claims.

### Exemplary Embodiment

### [1. Configuration]

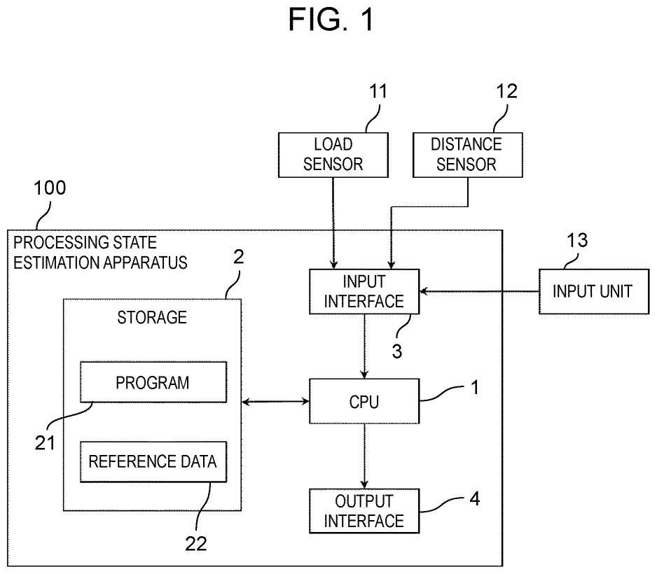

FIG. 1 is a block diagram illustrating a configuration example of processing state estimation apparatus 100 according to an exemplary embodiment of the present disclosure. Processing state estimation apparatus 100 includes CPU 1, storage 2, input interface (I/F) 3, and output interface (I/F) 4.

CPU 1 performs information processing to realize a function of processing state estimation apparatus 100 to be described later. Such information processing is realized, for example, by CPU 1 operating according to commands of program 21 stored in storage 2. CPU 1 is an example of a processor of the present disclosure. The processor may include an arithmetic circuit that performs an arithmetic operation for the information processing, and is not limited to the CPU. For example, the processor may include a circuit such as an MPU or an FPGA.

Storage 2 is a recording medium that records various types of information including data such as reference data 22 including a reference waveform to be described later, and program 21 necessary for realizing the function of processing state estimation apparatus 100. Storage 2 is implemented by a semiconductor storage such as a flash memory or a solid state drive (SSD), a magnetic storage such as a hard disk drive (HDD), or another recording medium, alone or in combination thereof, for example. Storage 2 may include a volatile memory such as an SRAM or a DRAM.

Input interface 3 is an interface circuit that connects processing state estimation apparatus 100 and an external device in order to input information from load sensor 11, distance sensor 12, and input unit 13 to the processing state estimation apparatus 100. Such an external device is a device such as load sensor 11, distance sensor 12, input unit 13, or another information processing terminal, for example. Input interface 3 may be a communication circuit that performs data communication according to an existing wired communication standard or wireless communication standard.

Output interface 4 is an interface circuit that connects processing state estimation apparatus 100 and an external output apparatus in order to output information from processing state estimation apparatus 100. Such an output apparatus is, for example, a display or another information processing terminal. Output interface 4 may be a communication circuit that performs data communication according to an existing wired communication standard or wireless communication standard. Input interface 3 and output interface 4 may be implemented by similar hardware.

Input unit 13 is a device for inputting data, information, instructions, and the like by a user operation. Examples of input unit 13 include a keyboard, a mouse, a touch panel, a microphone, and the like. Input interface 3 receives an input of information based on a user operation via input unit 13.

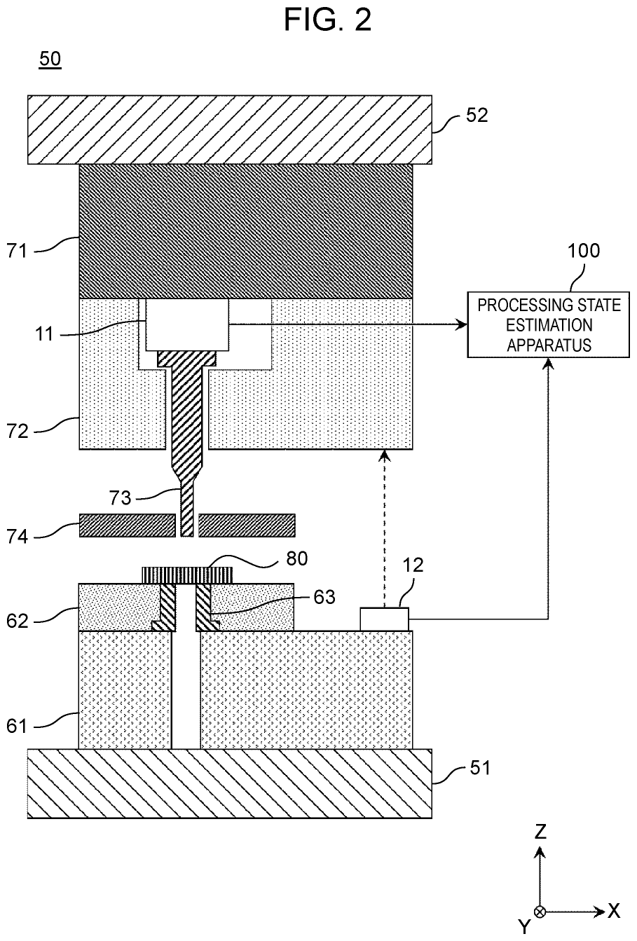

FIG. 2 is a schematic sectional view illustrating press machine 50 equipped with load sensor 11 and distance sensor 12 illustrated in FIG. 1. FIG. 2 illustrates an X-axis, a Y-axis, and a Z-axis orthogonal to each other for the sake of convenience of description. The Z-axis indicates the vertical direction.

Press machine 50 is an example of a processing machine that performs cycle processing of repeating predetermined processing. Press machine 50 includes bolster 51 and slide 52 that repeatedly performs a vertical reciprocating motion relative to the bolster 51 between a top dead center and a bottom dead center. Die backing plate 61 is attached on bolster 51, and die plate 62 is attached on die backing plate 61. Die plate 62 grips die 63.

Punch backing plate 71 is attached to a lower portion of slide 52, and punch plate 72 is attached to a lower portion of punch backing plate 71. Punch plate 72 grips punch 73. Press machine 50 further includes stripper plate 74. Stripper plate 74 is attached to a fastener such as a bolt and punch plate 72 or punch backing plate 71 using a positioning guide such as a post (not illustrated), for example. Stripper plate 74 is pressed downward by a compression spring, for example, and has at least one of a function of guiding punch 73 to locate punch 73 at a constant position, a function of extracting a material attached to punch 73 after punching workpiece 80, and a function of fixing workpiece 80 at the time of punching workpiece 80.

Load sensor 11 is installed between punch 73 and punch backing plate 71, for example. Load sensor 11 is a piezoelectric force sensor, a semiconductor strain sensor, or an electric force sensor of a strain gauge type or the like, for example, and measures a load applied to punch 73 when punch 73 punches workpiece 80. The unit is, for example, Newton (N).

Distance sensor 12 is installed on die backing plate 61, for example. Distance sensor 12 is an eddy current type gap sensor or a laser displacement meter, for example, and measures a distance to punch plate 72 facing in the Z-axis direction, for example. The distance measured by distance sensor 12 indicates the relative position of punch 73 with respect to a predetermined reference position of press machine 50.

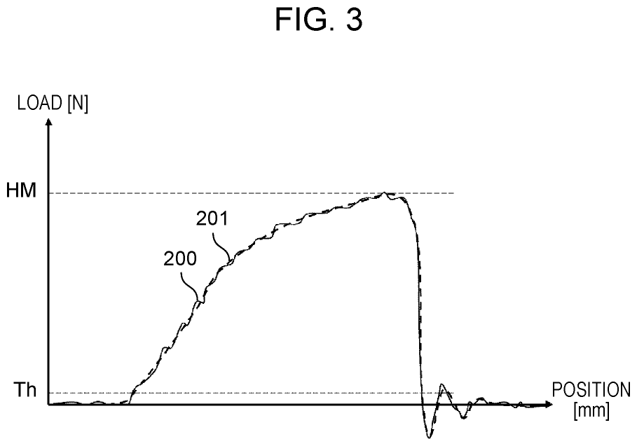

FIG. 3 is a schematic graph indicating an example of a measured waveform obtained by load sensor 11 and distance sensor 12. In the graph of FIG. 3, measured waveform 200 including the measurement noise is indicated by a solid line, and ideal waveform 201 not including the measurement noise is indicated by a broken line. FIG. 3 illustrates the graph with a horizontal axis representing a position of punch 73 with respect to an initial position. Distance sensor 12 measures a position of punch 73. The horizontal axis of the graph of FIG. 3 can also be referred to as a distance by which punch 73 has proceeded in a negative direction of the Z-axis. FIG. 3 illustrates the graph with a vertical axis representing a load measured by load sensor 11. When measured waveform 200 and ideal waveform 201 are compared with each other, it can be seen that the measurement noise exists over the entire measured waveform 200, and it is expected that the accuracy deteriorates if the estimation is performed without considering the measurement noise.

Measured waveform 200 is discrete data indicating the relationship between the load obtained by load sensor 11 and the position obtained by distance sensor 12. The discrete data number n is represented as an integer of 2 or more.

However, the measured waveform of the present disclosure is not limited to the waveform indicating the relationship between the load and the position. In the processing state estimation apparatus according to the present disclosure, since the processing apparatus performs the same cycle processing, for example, the relationship between time and load may be acquired as a measured waveform. The time during which punch 73 is in the initial position corresponds to the processing start time, and in view of the lowering speed of distance sensor 12, the horizontal axis of the graph of FIG. 3 can be replaced with the time during which the processing has progressed. That is, measured waveform 200 is also discrete data with respect to time.

Measured waveform 200 in FIG. 3 represents the entire one processing cycle including the start of lowering of punch 73, punching, raising of punch 73, and stopping of punch 73 for the punching. Measured waveform 200 indicates a mountain-like waveform that rises from the time point when punch 73 is lowered and comes into contact with workpiece 80, reaches the peak value HM of the load, and then the load rapidly decreases to near 0 after workpiece 80 is punched out.

The punching period of the punching can be determined as, for example, a period from a time point at which the load first exceeds the threshold Th in the measured waveform to a time point at which the load first falls below the threshold Th. Such a threshold value Th may be determined as an absolute value or may be determined as a percentage of a peak value of the load. Further, the threshold value is not limited to one, and may be equal to or more than two. For example, the rising threshold and the falling threshold are stored in storage 2, and CPU 1 may set, as the punching period, a period from a time point at which the load first exceeds the rising threshold to a time point at which the load first falls below the falling threshold in the measured waveform.

### [2. Operation]

### [2.1. Overall Operation]

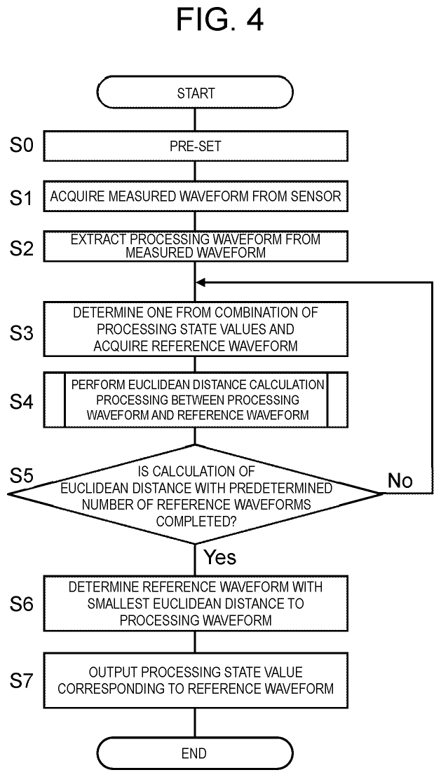

The overall operation of the processing state estimation processing will be described with reference to FIGS. 4 to 6. FIG. 4 is a flowchart indicating a procedure of the processing state estimation processing executed by CPU 1 of processing state estimation apparatus 100 in FIG. 1.

Before starting processing, CPU 1 performs preset in accordance with an instruction from the user or the like (S0). In step S0, CPU 1 can set a parameter used to calculate a Euclidean distance, for example, a metric tensor to be described later. The preset in step S0 will be described in detail later.

CPU 1 acquires, from load sensor 11 and distance sensor 12, a measured waveform indicating a time-series measurement result of a series of position data measured by distance sensor 12 and load data applied to load sensor 11 corresponding thereto (S1). Hereinafter, in a case where it is necessary to combine the position data and the load data, the position data and the load data are collectively referred to as measurement data, and an arbitrary point of the measurement data is referred to as a measurement point. In the present exemplary embodiment, the measurement data is a set of a plurality of measurement points.

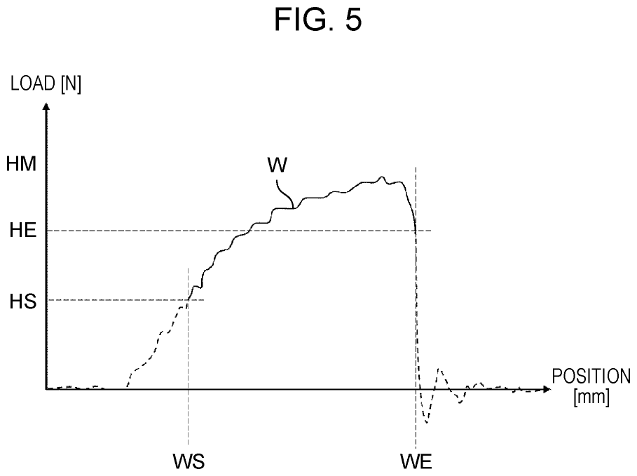

Next, CPU 1 extracts a processing waveform to be processed by CPU 1 from the measured waveform obtained in step S1 (S2). FIG. 5 is a diagram for explaining a processing waveform W extracted from the measured waveform. For example, CPU 1 acquires the start point load HS and the end point load HE from storage 2, determines the start point WS corresponding to the start point load HS and the end point WE corresponding to the end point load HE in the measured waveform, and sets a portion between the start point WS and the end point WE in the measured waveform as processing waveform W. In FIG. 5, processing waveform W is indicated by a solid line.

The start point WS of processing waveform W is determined, for example, as a position that first exceeds the start point load HS. The starting load HS is obtained by multiplying the peak value HM of the load by a value of a predetermined ratio set in advance. The end point WE in processing waveform W is determined as, for example, a position finally below the end point load HE. The end point load HE is obtained by multiplying the peak value HM of the load by a value of a predetermined ratio set in advance. However, the method of determining the start point and the end point of processing waveform W is not limited thereto. For example, CPU 1 may determine the start point and the end point using preset measurement points as the start point load and the end point load.

Returning to FIG. 4, CPU 1 refers to reference data 22, determines one of the combinations of the processing state values, and acquires a reference waveform (S3).

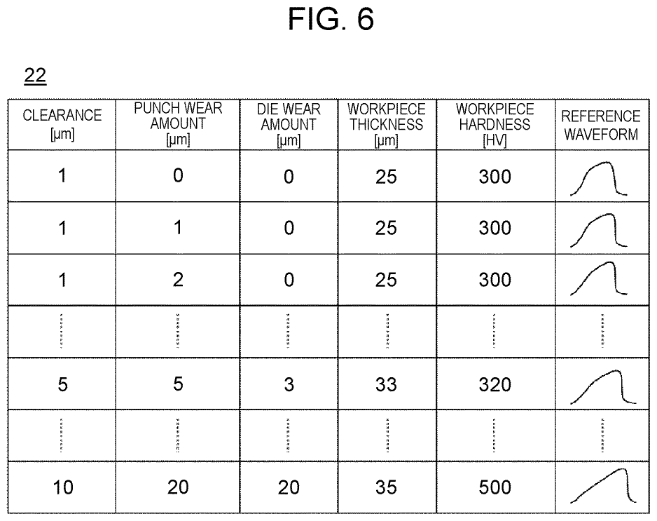

FIG. 6 is a table illustrating an example of reference data 22 illustrated in FIG. 1. Reference data 22 is a database including a data set including a combination of a plurality of processing state values and a reference waveform corresponding to the combination. According to the present exemplary embodiment, the processing state values include values representing the clearance, the punch wear amount, the die wear amount, the workpiece thickness, and the workpiece hardness.

In step S3, CPU 1 determines one combination from among the combinations of processing state values in reference data 22 (for example, the i-th combination in the reference data 22, where i is an integer equal to or greater than 1), and acquires a reference waveform. The clearance, the punch wear amount, the die wear amount, the workpiece thickness, and the workpiece hardness in reference data 22 are discrete state values, and reference data 22 is configured by a combination thereof. For example, the clearance ranges from 1 μm to 10 μm in steps of 1 μm, the punch wear amount ranges from 0 μm to 20 μm in steps of 1 μm, the die wear amount ranges from 0 μm to 20 μm in steps of 1 μm, the workpiece thickness ranges from 25 μm to 35 μm in steps of 1 μm, and the workpiece hardness ranges from 300 HV to 500 HV in steps of 20 HV.

The reference waveform acquired in step S3 is obtained in advance by simulation or the like using a combination of the clearance, the punch wear amount, the die wear amount, the workpiece thickness, and the workpiece hardness, and is stored in, for example, storage 2.

Returning to FIG. 4, next, CPU 1 performs Euclidean distance calculation processing of calculating a Euclidean distance between processing waveform W and one reference waveform acquired in step S3 (S4). The Euclidean distance is an index indicating the similarity, and indicates that the shorter the Euclidean distance, the larger the similarity of the waveform. The calculation processing in step S4 will be described in detail later.

The Euclidean distance calculation processing S4 of processing waveform W and the reference waveform is repeatedly executed a predetermined number of times while changing the combination of the processing state values determined in step S3. For example, the integer i is incremented each time the processing of steps S3 to S4 is executed. By repeating the processing of steps S3 to S4, CPU 1 searches for a reference waveform having the shortest Euclidean distance to processing waveform W (in the search range).

In order to perform the processing of steps S3 to S4 a predetermined number of times, CPU 1 determines whether the calculation of the Euclidean distance between processing waveform W and the predetermined number of reference waveforms has been completed (S5). The predetermined number is an integer of 2 or more. The predetermined number may match the number of rows N of reference data 22, for example. In this case, CPU 1 compares processing waveform W with all the reference waveforms in reference data 22.

Alternatively, the predetermined number may be smaller than the number of rows N of reference data 22. For example, CPU 1 compares the processing waveform with each of the i-th to (i+k)th reference waveforms. Here, k is a predetermined integer of 1 or more, and (i+k)<N. As a result, in step S5, it is possible to determine whether or not the search for the processing state value close to the processing state value in the processing cycle one time before the current processing cycle has been completed.

In a case where it is determined that the comparison with the predetermined number of reference waveforms has not been completed (No in S5), CPU 1 returns to step S3 and starts the processing of determining another reference data (for example, (i+1)th reference data) again.

On the other hand, in a case where it is determined that the comparison with the predetermined number of reference waveforms has been completed (Yes in S5), CPU 1 determines a reference waveform having the shortest Euclidean distance among the reference waveforms for which the Euclidean distance to processing waveform W has been calculated (S6).

Next, CPU 1 outputs the processing state values corresponding to the reference waveform determined in step S6 (S7). As the output of step S7, for example, the processing state estimation apparatus 100 displays a trend displaying the transition of the processing state values for the user as a graph. As a result, the user can perform maintenance of the tool or the like or adjustment of the processing condition as necessary by referring to the processing state values.

### [2.2. Euclidean Distance Calculation Processing]

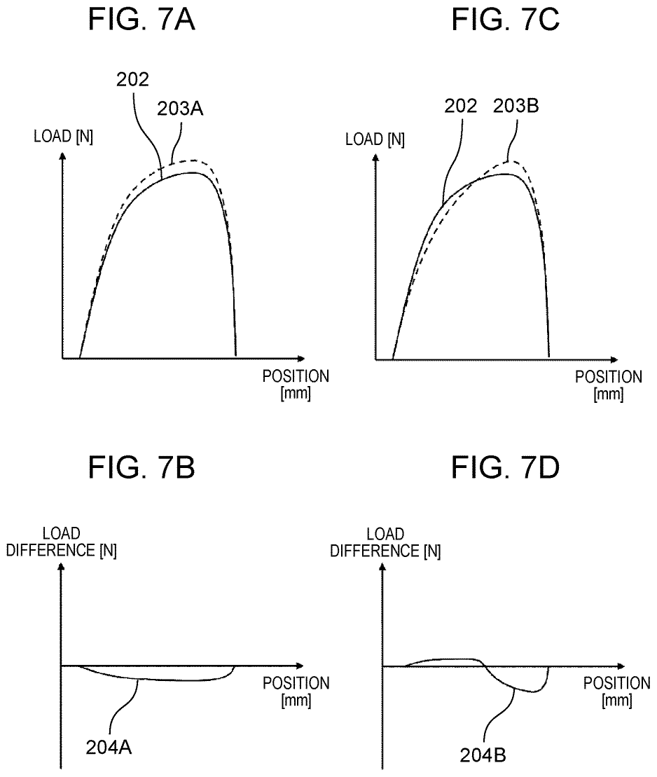

The Euclidean distance between the processing waveform and the reference waveform due to the differences in the reference waveforms will be described with reference to FIGS. 7A to 7D. FIG. 7A illustrates a graph in which processing waveform 202 and reference waveform 203A are overlapped, and FIG. 7B illustrates difference waveform 204A indicating a difference between processing waveform 202 and reference waveform 203A at each measurement point. FIG. 7C illustrates a graph in which processing waveform 202 and reference waveform 203B are overlapped, and FIG. 7D illustrates a difference waveform 204B obtained from a difference between processing waveform 202 and reference waveform 203B at each measurement point. The vertical axis of the graphs of FIGS. 7B and 7D represents the load difference [N]. Specifically, subtracting processing waveform 202 indicated by a solid line from reference waveform 203A indicated by a broken line in FIG. 7A results in difference waveform 204A in FIG. 7B. Similarly, subtracting processing waveform 202 indicated by a solid line from reference waveform 203B indicated by a broken line in FIG. 7C results in difference waveform 204B in FIG. 7D.

The Euclidean distance calculated based on the difference waveform 204A and the Euclidean distance calculated based on difference waveform 204B by the conventional method have substantially the same value although the shapes of difference waveform 204A and difference waveform 204B are greatly different. However, when it is determined from the characteristics of the actual processing state, it can be said that reference waveform 203A is more similar to processing waveform 202 than reference waveform 203B. In the estimation processing of the processing state, if the similarity between processing waveform 202 and the reference waveform is not appropriately reflected in the Euclidean distance, the accuracy of the estimation of the processing state may deteriorate.

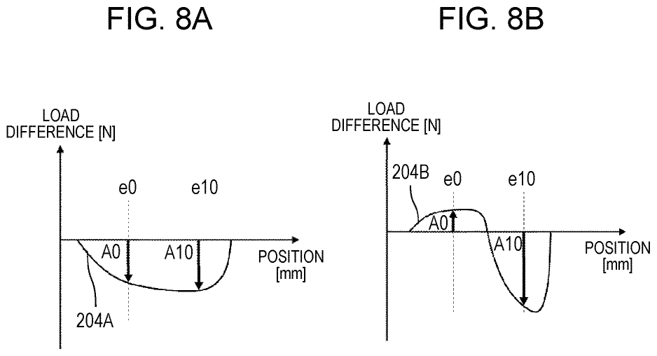

FIGS. 8A and 8B are diagrams illustrating the difference waveform 204A illustrated in FIG. 7B and the difference waveform 204B illustrated in FIG. 7D in more detail, respectively. An example of calculating the Euclidean distance by a conventional method will be described with reference to FIGS. 8A and 8B. In FIGS. 8A and 8B, each difference waveform is considered as two-dimensional data discretized into two in the position direction. Difference waveforms 204A and 204B are represented by difference vectors A0 and A10. In addition, difference vector A0 is a vector expressed with basis vector e0 as a basis, and difference vector A10 is a vector expressed with basis vector e10 as a basis. In a case where basis vectors e0 and e10 are in an orthonormal relationship, the Euclidean distance (that is, the length of vector A) is expressed by the following Formula 1.

[Formula 1]

|A|=\sqrt{(A0·e0)²+(A10·e10)²} (1)

As can be seen from Formula 1, difference waveforms 204A and 204B may have similar Euclidean distances even in a case where they have different shapes. This is because the difference vectors are equally incorporated into the calculation of the Euclidean distance regardless of the shape of the difference waveform. In order to improve this, when calculating the Euclidean distance from the difference vectors corresponding to the measurement points separated from each other in the position direction (that is, temporally), weighting is considered so that the feature of the processing state can be easily reflected.

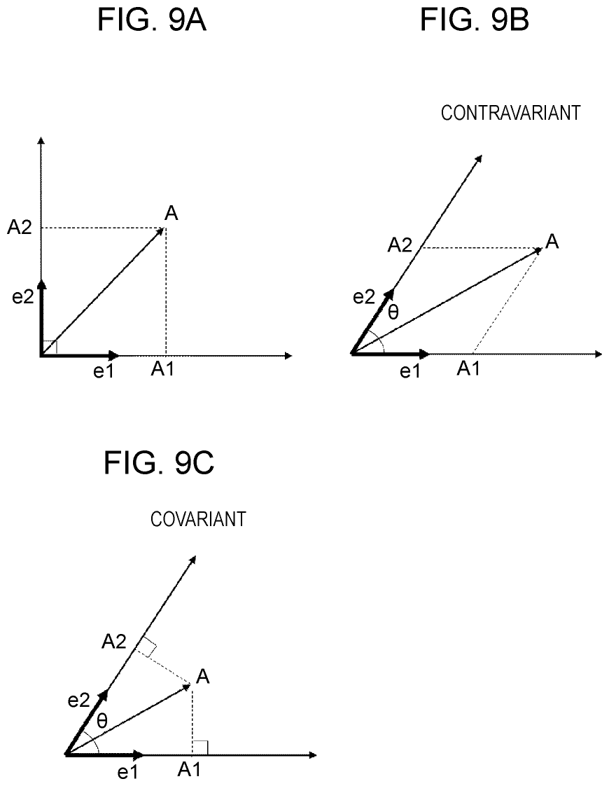

In weighting, the concept of vector calculation using an oblique coordinate system is used. FIGS. 9A to 9C are diagrams illustrating an example in which vectors are expressed in an orthonormal coordinate system and an oblique coordinate system, in which FIG. 9A is a diagram for describing a vector in the orthogonal coordinate system, FIG. 9B is a diagram for describing a contravariant vector in the oblique coordinate system, and FIG. 9C is a diagram for describing a covariant vector in the oblique coordinate system. For ease of explanation, both are illustrated by limiting to two dimensions in which A1 and A2 are vector values.

FIG. 9A illustrates an orthonormal coordinate system in which all basis vectors have a length of 1. That is, the angle formed by basis vectors e1 and e2 is 90°.

On the other hand, FIGS. 9B and 9C illustrate an oblique coordinate system, and all the basis vectors have a length of 1 but are not in an orthogonal relationship. In the example illustrated in FIGS. 9B and 9C, the angle θ formed by basis vectors e1 and e2 is set to less than 90°.

FIG. 9B illustrates a case where vector A is expressed as a contravariant vector, and vector A in a two-dimensional case is expressed by the following Formula 2.

[Formula 2]

A=A1·e1+A2·e2 (2)

FIG. 9C illustrates a case where vector A is expressed as a covariant vector, and vector values A1 and A2 are expressed as inner products of basis vectors e1 and e2 and vector A as in the following Formula 3.

$$\begin{matrix}[ Formula 3 ] & \\ \{ \begin{matrix}A 1 = A \cdot e 1 \\ A 2 = A \cdot e 2\end{matrix} & ( 3 )\end{matrix}$$

In the case of the orthonormal coordinate system illustrated in FIG. 9A, both Formula 2 and Formula 3 hold. That is, in the case of an orthonormal coordinate system, vector A is the same vector regardless of whether vector A is represented by a contravariant vector or a covariant vector, and both vectors are represented by the same formula.

In a case where the angle θ formed by basis vectors e1 and e2 is less than 90°, in a case where vector A is treated as a covariant vector, the length of vector A is shorter than that in a case represented in an orthonormal coordinate system. That is, the length of vector A in FIG. 9C is shorter than the length of vector A in FIG. 9A. On the other hand, in a case where the angle θ formed by basis vectors e1 and e2 is less than 90°, in a case where vector A is treated as a contravariant vector, the length of vector A is longer than that in a case represented in an orthonormal coordinate system. That is, the length of vector A in FIG. 9B is longer than the length of vector A in FIG. 9A.

Therefore, by setting vector A as a covariant vector and setting the angle θ formed by basis vectors e1 and e2 to an appropriate value, that is, less than 90°, vector A can be handled so as to have a length shorter than that of the orthonormal coordinate system. In FIGS. 9A to 9C, the case of two dimensions has been described, but the same applies even if the dimensions become multidimensional.

Using the vector calculation in the oblique coordinate system described above, weighting can be performed so that the feature of the processing state can be easily reflected in the calculation of the Euclidean distance. In the examples of FIGS. 8A and 8B, the angle formed between basis vectors e0 and e10 is set to an oblique coordinate system of less than 90°, and vector A including two difference vectors A0 and A10 is set to a covariant vector. As a result, vector A becomes a vector having a length shorter than the length in the orthogonal coordinate system. The length of the vector (that is, the Euclidean distance) can be weighted by adjusting the angle of any two difference vectors. That is, by changing the angle formed by the basis vector by reflecting the relationship between the two measurement points, it is possible to calculate the Euclidean distance with higher accuracy for the processing waveform.

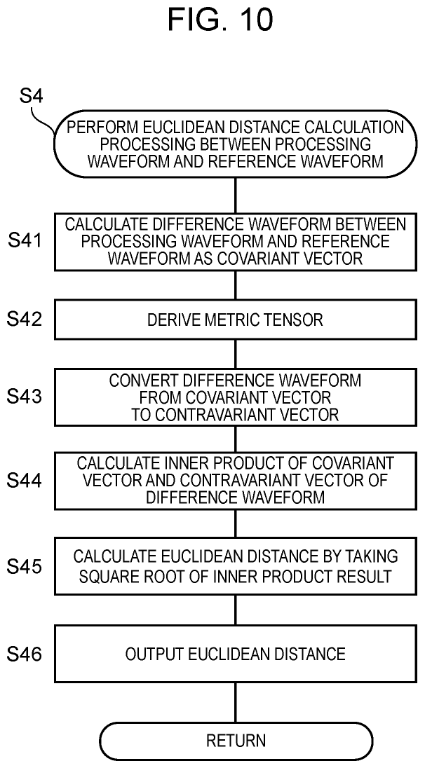

Euclidean distance calculation processing S4 will be described on the premise of the concepts described with reference to FIGS. 7A to 7D, FIGS. 8A and 8B, and FIGS. 9A to 9C. FIG. 10 is a flowchart illustrating a procedure of Euclidean distance calculation processing S4 illustrated in FIG. 4.

In Euclidean distance calculation processing S4, CPU 1 first calculates a difference waveform between processing waveform W and the reference waveform as a covariant vector (S41).

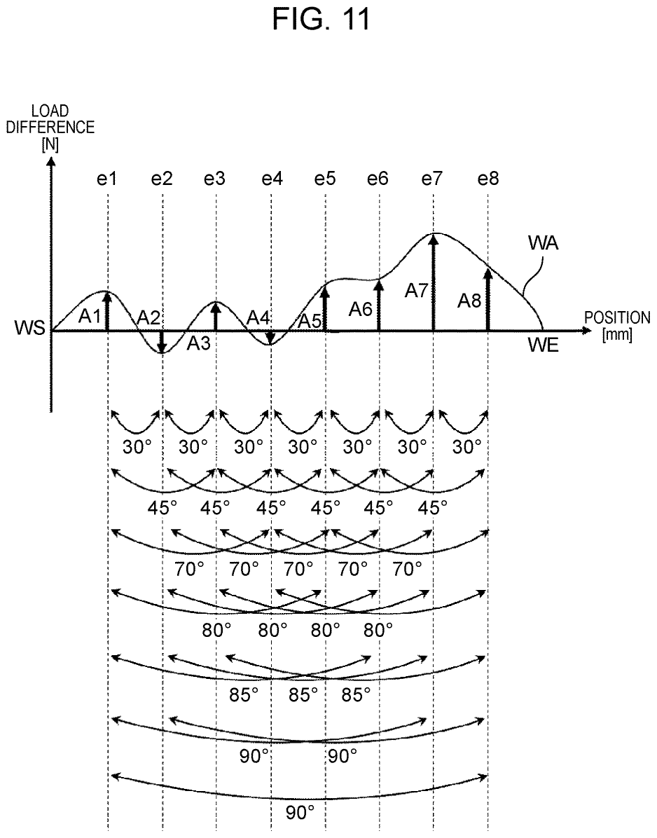

FIG. 11 is a diagram illustrating processing of calculating a difference waveform between a processing waveform W and a reference waveform as a covariant vector. FIG. 11 illustrates an example in which a difference waveform is represented as 8-dimensional data discretized into 8 in the position direction. CPU 1 calculates a Euclidean distance for a difference waveform WA including eight difference vectors A1 to A8 corresponding to a plurality of measurement points during a processing cycle. Hereinafter, the difference waveform WA will be described in association with vector A as the covariant vector. Therefore, difference vectors A1 to A8 are vectors expressed with respect to basis vectors e1 to e8 as bases, and are handled as covariant vectors. The length of vector A is substantially the Euclidean distance.

In the present exemplary embodiment, the difference waveform WA is exemplified as 8-dimensional data, that is, an 8-dimensional vector A in order to facilitate the description, but the number of dimensions may be two or more and is not limited thereto. For example, by representing the difference waveform WA with a dimension larger than eight dimensions, the difference waveform WA can be treated as a smoother waveform corresponding to processing waveform W that is the calculation source.

Basis vectors e1 to e8 respectively corresponding to difference vectors A1 to A8 have a length of 1, and an angle formed by any two basis vectors is set to less than or equal to 90°. In the example of FIG. 11, two basis vectors that are closer to each other with respect to the position direction (that is, the time interval is small) are set to a small angle close to 0°, and two basis vectors that are farther from each other (that is, the time interval is large) are set to an angle close to 90°. For example, the angle between basis vectors e1 and e2 is set to 30°, the angle between basis vectors e1 and e3 is set to 45°, the angle between basis vectors e1 and e4 is set to 70°, the angle between basis vectors e1 and e5 is set to 80°, the angle between basis vectors e1 and e6 is set to 85°, and the angle between basis vectors e1 and e7 and basis vectors e1 and e8 is set to 90°.

By changing the angle between the two basis vectors as described above, it is possible to calculate the Euclidean distance after performing weighting in which the characteristics of the processing state are easily reflected. A specific example of the feature of the processing state will be described later.

In FIG. 11, the angle formed by basis vectors e1 to e8 is 30° to 90°, but the present disclosure is not limited thereto. For example, the angle formed by basis vectors e1 to e8 may be set to 450 to 80°.

Returning to FIG. 10, CPU 1 derives the metric tensor (S42). The metric tensor can be used to convert covariant vectors into contravariant vectors. Hereinafter, the contravariant vector with respect to vector A is A′. In a case where the lengths of all the basis vectors are 1, the metric tensor is expressed as the following Formula 4 by using a degree measure for angles, for example.

$$\begin{matrix}[ Formula 4 ] & \\ g = ( \begin{matrix}cos 0 & cos 30 & cos 45 & cos 70 & cos 80 & cos 85 & cos 90 & cos 90 \\ cos 30 & cos 0 & cos 30 & cos 45 & cos 70 & cos 80 & cos 85 & cos 90 \\ cos 45 & cos 30 & cos 0 & cos 30 & cos 45 & cos 70 & cos 80 & cos 85 \\ cos 70 & cos 45 & cos 30 & cos 0 & cos 30 & cos 45 & cos 70 & cos 80 \\ cos 80 & cos 70 & cos 45 & cos 30 & cos 0 & cos 30 & cos 45 & cos 70 \\ cos 85 & cos 80 & cos 70 & cos 45 & cos 30 & cos 0 & cos 30 & cos 45 \\ cos 90 & cos 85 & cos 80 & cos 70 & cos 45 & cos 30 & cos 0 & cos 30 \\ cos 90 & cos 90 & cos 85 & cos 80 & cos 70 & cos 45 & cos 30 & cos 0\end{matrix} ) & ( 4 )\end{matrix}$$

The elements of the matrix in Formula 4 are expressed by inner products of the basis vectors corresponding to the row numbers and the column numbers, where the row and column numbers correspond to the indices of the basis vectors, and the inner products are determined based on the angles between the basis vectors. Note that the derivation of the metric tensor in step S42 is not necessary in a case where the derivation and the setting are performed in advance in the preset of step S0, and the preset data can be used later.

Next, CPU 1 converts the difference waveform from a covariant vector to a contravariant vector (S43).

Using the metric tensor obtained in step S42, a covariant vector can be converted into a contravariant vector by the following Formula 5. g⁻¹ is an inverse matrix of the metric tensor g.

[Formula 5]

A′=g⁻¹A (5)

Next, CPU 1 calculates an inner product of the covariant vector and the contravariant vector of the difference waveform (S44). The inner product is the square of the length (Euclidean distance) of vector A.

Regarding the calculation of the inner product, in a case where all the basis vectors have an orthonormal relationship, the length of vector A can be calculated by obtaining the inner product of vector A itself. That is, the square of the length of vector A is expressed as Formula 6.

$$\begin{matrix}[ Formula 6 ] & \\ {\vert A \vert}^{2} = {\sum }_{n = 1}^{8} A \cdot A & ( 6 )\end{matrix}$$

On the other hand, in the case of an oblique coordinate system that does not have an orthonormal relationship among the basis vectors, the calculation cannot be performed by the inner product of vector A itself shown in Formula 6. The calculation can be performed by setting one of the two vectors A to covariant vector A and setting the other to contravariant vector A′ converted from covariant vector A by Formula 5. That is, in the case of the oblique coordinate system, the square of the length of vector A is expressed by Formula 7.

$$\begin{matrix}[ Formula 7 ] & \\ {\vert A \vert}^{2} = {\sum }_{n = 1}^{8} A \cdot {A}^{′} & ( 7 )\end{matrix}$$

Next, CPU 1 calculates a Euclidean distance by taking the square root of the inner product result (S45), outputs the Euclidean distance (S46), and then terminates the Euclidean distance calculation process S4 and proceeds to step S5.

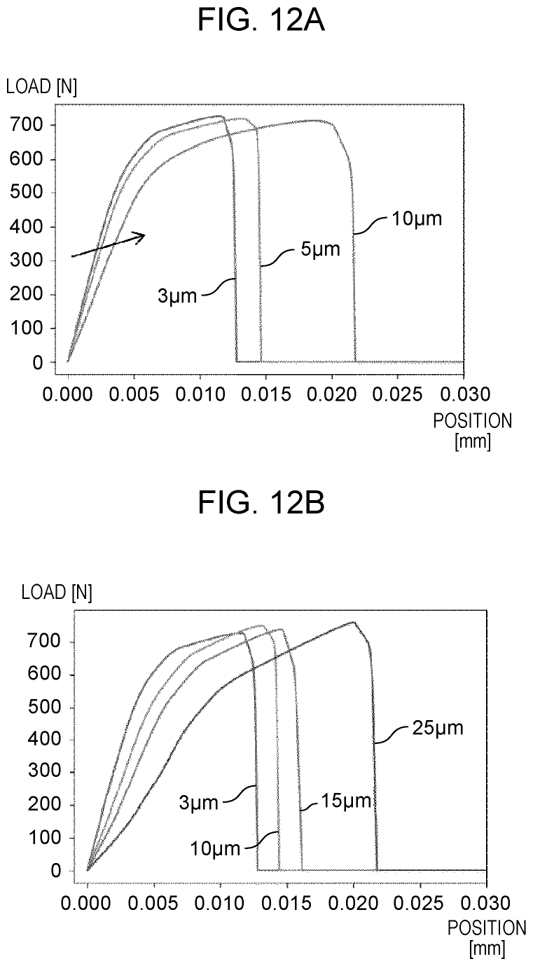

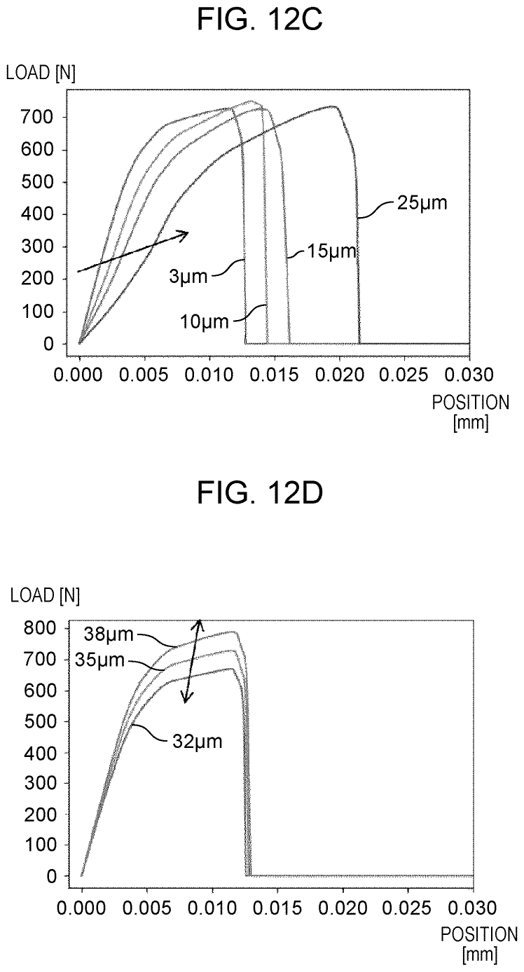

The change in the waveform corresponding to the change in the characteristic of the processing state of the processing machine will be described with reference to FIGS. 12A to 12D. FIGS. 12A to 12D are graphs showing load waveforms obtained by a simulation of a punching process.

FIG. 12A is a graph showing a plurality of load waveforms obtained by changing the clearance in a simulation in which the punch wear amount and the die wear amount are 3 μm, the workpiece thickness is 35 μm, and the workpiece hardness is 600 HV. The graph of FIG. 12A shows simulation results with clearances of 3 μm, 5 μm, and 10 μm. The arrow in FIG. 12A indicates a direction in which the tendency of the load waveform mainly changes in a case where the clearance is increased.

FIG. 12B is a graph showing a plurality of load waveforms obtained by changing the punch wear amount in a simulation in which the die wear amount and the clearance are 3 μm, the workpiece thickness is 35 μm, and the workpiece hardness is 600 HV. The graph of FIG. 12B shows simulation results with the punch wear amounts of 3 μm, 10 μm, 15 μm, and 25 μm. The arrow in FIG. 12B indicates a direction in which the tendency of the load waveform mainly changes in a case where the punch wear amount is increased.

FIG. 12C is a graph showing a plurality of load waveforms obtained by changing the die wear amount in a simulation in which the punch wear amount and the clearance are 3 μm, the workpiece thickness is 35 μm, and the workpiece hardness is 600 HV. The graph of FIG. 12C shows simulation results with the die wear amounts of 3 μm, 10 μm, 15 μm, and 25 μm. The arrow in FIG. 12C indicates a direction in which the tendency of the load waveform mainly changes in a case where the die wear amount is increased.

FIG. 12D is a graph showing a plurality of load waveforms obtained by changing the workpiece thickness in a simulation in which the punch wear amount, die wear amount and the clearance are 3 μm, and the workpiece hardness is 600 HV. The graph of FIG. 12D shows simulation results with workpiece thicknesses of 32 μm, 35 μm, and 38 μm. The arrow in FIG. 12D indicates a direction in which the tendency of the load waveform mainly changes in a case where the workpiece thickness is increased.

As illustrated in FIGS. 12A to 12D, the waveform greatly changes depending on the position direction (passage of time) along with the change in the characteristic of the processing state. That is, the positional relationship (for example, the component parallel to the arrows in FIGS. 12A to 12D of the distance between the measurement points) between the measurement points having a distant relationship (large time interval) in the positional direction largely depends on the change in the characteristic of the processing state. On the other hand, in the positional relationship between the measurement points having a relationship close to the positional direction (small time interval), the dependence on the change in the characteristic of the processing state is small, that is, only a smooth change is involved. Therefore, in order to calculate the Euclidean distance in consideration of the feature of the processing state, it is desirable that a plurality of measurement points having a far relationship in the position direction have a weight.

On the other hand, as illustrated in measured waveform 200 in FIG. 3, the measurement noise has a relationship close to the position direction. Therefore, in order to be hardly affected by the measurement noise, it is desirable that there is no weight for the load having a relationship close to the position direction.

As described with reference to FIGS. 8A and 8B and FIGS. 9A to 9C, in order to calculate the Euclidean distance obtained from the measurement points far from each other in the positional direction to be long and calculate the Euclidean distance obtained from the measurement points close to each other to be short, it is sufficient to configure the oblique coordinate system and set the angle between the basis vectors forming the plurality of difference vectors. Therefore, by using the oblique coordinate system, the influence of the measurement noise can be reduced, the weighted Euclidean distance reflecting the feature of the processing state can be calculated, and the processing state of the processing machine can be estimated more accurately than in the related art.

### [2.3. Preset]

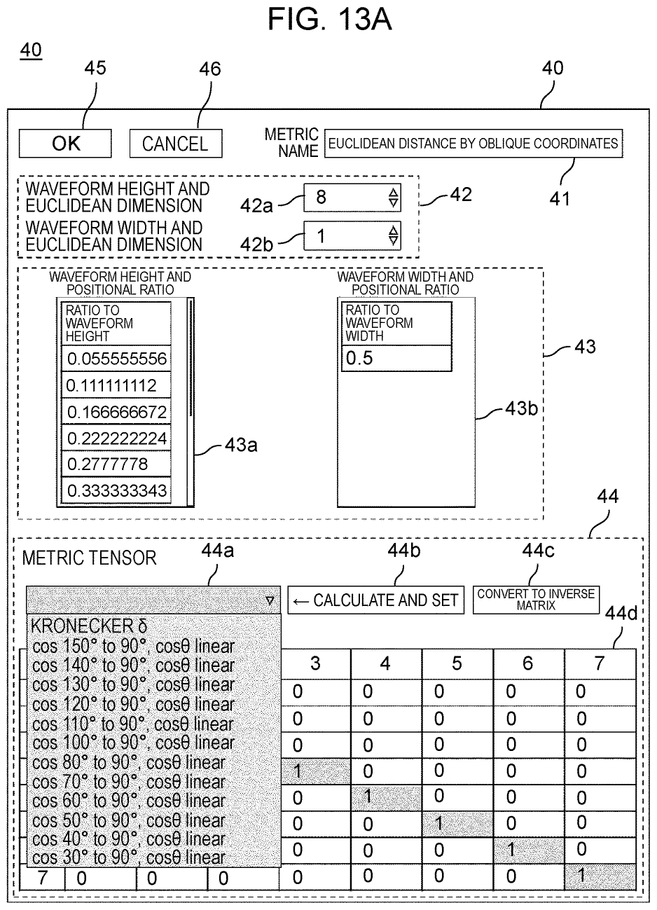

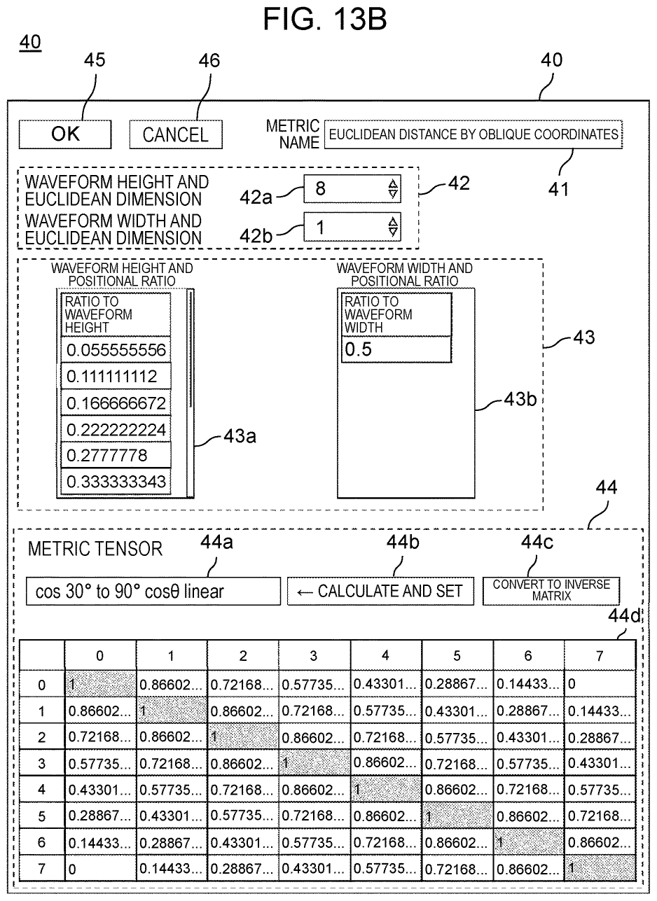

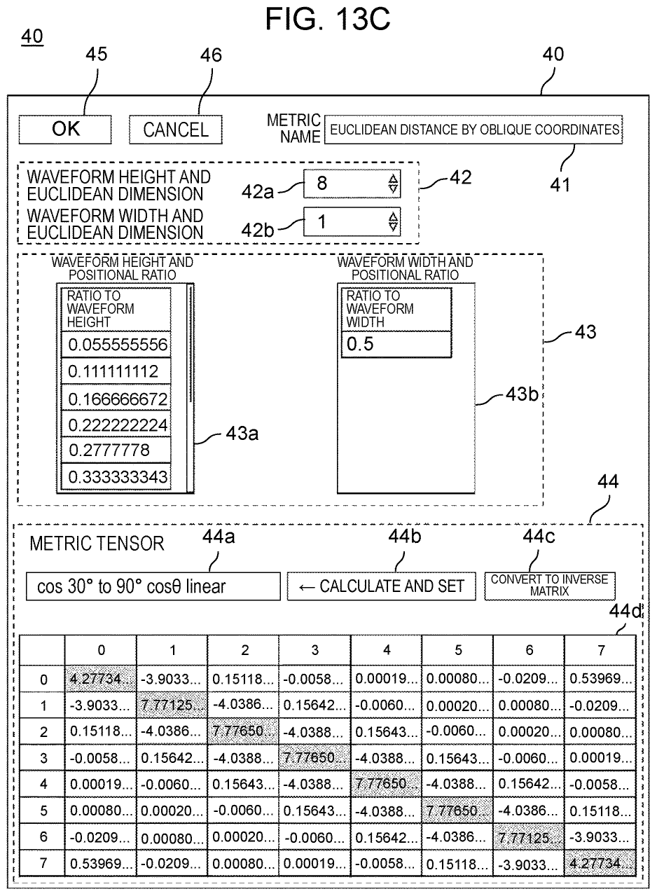

The preset in step S0 will be described in detail. FIGS. 13A to 13C (hereinafter, in a case where there is no need to distinguish, it is referred to as FIG. 13.) are diagrams illustrating examples of the preset screen 40 displayed by CPU 1 via the output I/F. By inputting each item on preset screen 40, the user can set the processing state estimation processing by CPU 1.

Preset screen 40 displays input areas 41 to 43, selection area 44, and buttons 45 and 46. A metric name is input to input area 41. Euclidean dimensions of the waveform height and the width can be input to input area 42. The positional ratios of the waveform height and width can be input to input area 43. In the selection region 44, the user can select and set a metric tensor. Buttons 45 and 46 are used to complete or cancel the preset, respectively. Note that, on the preset screen 40, items other than those necessary for explanation are omitted, and arrangement and the like of the items are not limited unless otherwise specified. The description and contents of each item are illustrative and not limited thereto.

In FIG. 13, input area 41 is a setting screen for calculating the Euclidean distance by the oblique coordinates using the “EUCLIDEAN DISTANCE BY THE OBLIQUE COORDINATES” as a metric name.

Input area 42 includes input area 42a of “WAVEFORM HEIGHT AND EUCLIDEAN DIMENSION” and input area 42b of “WAVEFORM WIDTH AND EUCLIDEAN DIMENSION”. An integer of 1 or more can be input to input area 42a and input area 42b. In the example of FIG. 13, the waveform height and Euclidean dimension are set to 8, and the waveform width and Euclidean dimension are set to 1 in accordance with the example of the present exemplary embodiment.

Input area 43 includes input area 43a of “WAVEFORM HEIGHT AND POSITIONAL RATIO” and input area 43b of “WAVEFORM WIDTH AND POSITIONAL RATIO”. In input area 43, positions of measurement points set as basis vectors can be input according to the number of dimensions of input area 42. Note that the position of the measurement point may be input as a ratio to the waveform height or the waveform width, or may be input as an absolute value.

In selection area 44, drop-down list 44a for the angle, calculation button 44b, transform button 44c, and matrix display area 44d are displayed. As illustrated in FIG. 13A, the user can determine the range of the angle θ between the basis vectors using drop-down list 44a. In FIGS. 13B and 13C, “cos 30° to 90° cos θ linear” is selected. In “cos 30° to 90° cos θ linear”, the angle θ between the basis vectors is set to change linearly between 30° and 90°.

When calculation button 44b is pressed, CPU 1 calculates a metric tensor based on the range of the angle θ determined by drop-down list 44a, and displays data corresponding to the calculated metric tensor in display area 44d. In FIG. 13A, since the range of the angle θ is not selected by the drop-down list 44a, the numerical value of display area 44d is a numerical value based on the orthonormal coordinate system which is the initial value. In FIG. 13B, each element of the matrix is displayed as a numerical value in display area 44d based on “cos 30° to 90° cos θ linear” set in drop-down list 44a. When transform button 44c is pressed, the matrix displayed in display area 44d can be transformed into an inverse matrix. In FIG. 13C, numerical values obtained by converting the matrix displayed in FIG. 13B into an inverse matrix are displayed in display area 44d. The Euclidean distance can be calculated using this inverse matrix.

By inputting and selecting necessary portions among the items of input areas 41,42,43, and selection area 44, and finally pressing “OK” button 45, the content of preset screen 40 is confirmed as setting data, and the preset in step S0 is completed.

### [3. Effects and the Like]

As described above, processing state estimation apparatus 100 according to the present exemplary embodiment includes storage 2 and CPU 1, which is an example of the processor. The storage 2 stores a plurality of processing state values defining a processing state of press machine 50, which is an example of a processing machine, and a plurality of pieces of reference data each corresponding to a combination of the plurality of processing state values. CPU 1 acquires time-series measurement data measured in the processing of the press machine 50, and determines at least one piece of reference data from among the plurality of pieces of reference data (S3). CPU 1 determines a plurality of difference vectors based on differences between the measurement data and at least one piece of reference data at a plurality of measurement points temporally separated from each other. CPU 1 determines a Euclidean distance between the measurement data and at least one piece of reference data in the oblique coordinate system based on the plurality of difference vectors (S4). CPU 1 estimates the processing state based on the determined Euclidean distance (S6). The angle between the basis vectors forming the plurality of difference vectors is set to change depending on the time interval between the plurality of measurement points.

According to this configuration, unlike the related art, regarding the calculation of the similarity between the processing waveform obtained by sensing the processing point and the reference waveform, the influence of the measurement noise is reduced, and the processing state can be estimated more accurately based on the similarity weighted to the feature of the processing state of the processing machine. For example, CPU 1 can more accurately estimate a clearance, a punch wear amount, and a die wear amount which are processing state values. Therefore, maintenance can be performed at an appropriate timing by the operator referring to the processing state value or automatically stopping the equipment when the processing state value exceeds a set threshold.

In processing state estimation apparatus 100, the plurality of difference vectors are covariant vectors, and the angle between the basis vectors forming the plurality of difference vectors is larger than 0° and less than or equal to 90°. According to this configuration, the processing state value can be estimated more accurately than in the related art.

In processing state estimation apparatus 100, the angle between the basis vectors forming the plurality of difference vectors is set to be larger as the time interval is larger. According to this configuration, in the calculation of the Euclidean distance, weighting can be performed so as to reflect the feature of the processing state, and the processing state value can be estimated more accurately than in the related art.

Processing state estimation apparatus 100 further includes input unit 13 that receives an input of a user operation for setting an angle between basis vectors forming a plurality of difference vectors, and CPU 1 sets an angle between basis vectors forming a plurality of difference vectors based on the input of the user operation. According to this configuration, the angle can be set in advance, and the processing state value can be estimated more accurately than in the related art.

### Other Exemplary Embodiments

The exemplary embodiment is described above to exemplify the technique disclosed in the present application. However, the technique according to the present disclosure is not limited to the above exemplary embodiment, but is applicable to other exemplary embodiments including appropriate modifications, replacements, additions, omissions, and the like. Thus, modifications as other exemplary embodiments will be described below.

### (First Modification)

In the above exemplary embodiment, in the calculation of the Euclidean distance between the processing waveform and the reference waveform, the difference waveform between the processing waveform and the reference waveform is set as a covariant vector, and the angle between the basis vectors is set to 0° to 90°. However, the processing can also be performed using the difference waveform as a contravariant vector. In the present modification, the processing state estimation apparatus 100 calculates the Euclidean distance by setting the angle between the basis vectors to 90° to 180° with the difference waveform between the processing waveform and the reference waveform as a contravariant vector.

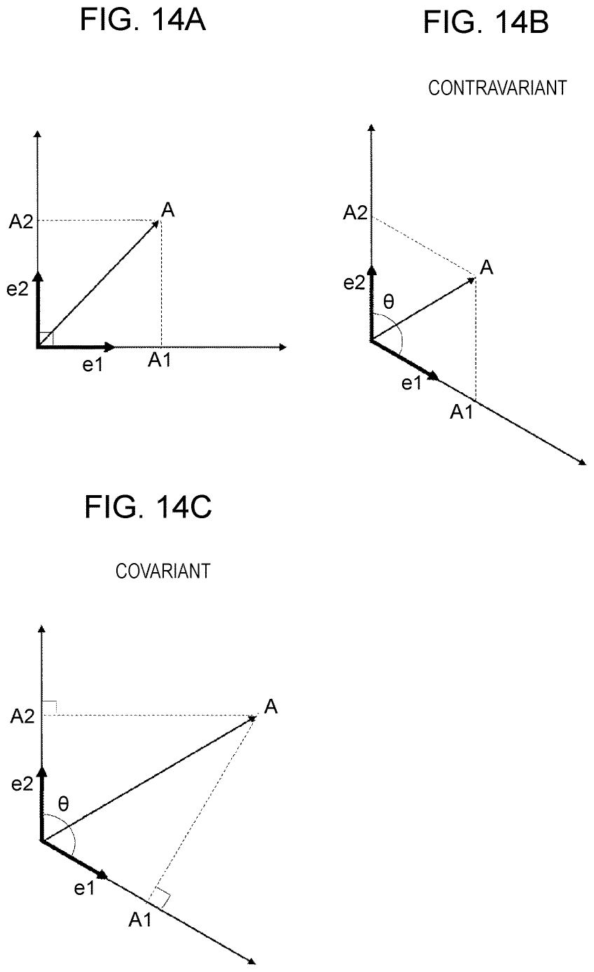

FIGS. 14A to 14C correspond to FIGS. 9A to 9C, and are different in that the angle θ formed by basis vectors e1 and e2 in the oblique coordinate system is set to be larger than 90° and smaller than 180°. In a case where the angle θ formed by basis vectors e1 and e2 is larger than 90° and smaller than 180°, vector A is treated as a covariant vector, whereby the length of vector A becomes longer than that in the case of being represented in the orthonormal coordinate system. That is, vector A in FIG. 14C is longer than vector A in FIG. 14A. On the other hand, in a case where the angle θ formed by basis vectors e1 and e2 is larger than 90° and smaller than 180°, vector A is treated as a contravariant vector, whereby the length of vector A becomes shorter than that in the case of being represented in the orthonormal coordinate system. That is, vector A in FIG. 14B is shorter than vector A in FIG. 14A.

Therefore, by setting vector A as a contravariant vector and setting the angle θ formed by basis vectors e1 and e2 to an appropriate value, that is, larger than 90° and smaller than 180°, vector A can be handled so as to have a length shorter than that of the orthonormal coordinate system.

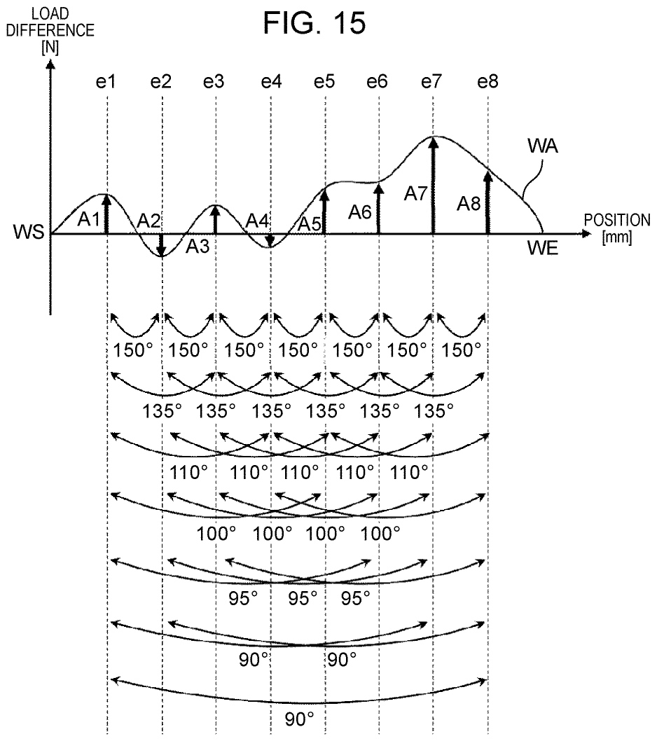

FIG. 15 corresponds to FIG. 11, and differs from FIG. 11 in that basis vectors e1 to e8 respectively corresponding to difference vectors A1 to A8 have a length of 1, and an angle formed by any two basis vectors is set to 90° or more and less than 180°. In the example of FIG. 15, two basis vectors that are closer to each other with respect to the position direction (that is, the time interval is small) are set to an angle close to 180°, and two basis vectors that are farther from each other (that is, the time interval is large) are set to an angle close to 90°. For example, the angle between basis vectors e1 and e2 is set to 150°, the angle between basis vectors e1 and e3 is set to 135°, the angle between basis vectors e1 and e4 is set to 110°, the angle between basis vectors e1 and e5 is set to 100°, the angle between basis vectors e1 and e6 is set to 95°, and the angle between basis vectors e1 and e7 and basis vectors e1 and e8 is set to 90°.

By changing the angle between the two basis vectors as described above, it is possible to calculate the Euclidean distance after performing weighting in which the characteristics of the processing state are easily reflected.

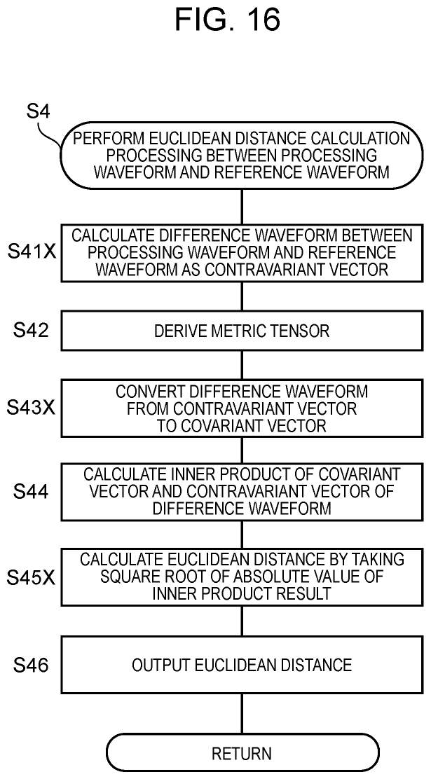

FIG. 16 corresponds to FIG. 10, and is different in that a difference waveform between the processing waveform and the reference waveform is treated as a contravariant vector. That is, in step S41, the difference waveform between the processing waveform and the reference waveform is calculated as a contravariant vector (S41X). In step S43, the difference waveform is converted from a contravariant vector to a covariant vector (S43X). In step S45, a Euclidean distance is calculated by taking the square root of the absolute value of the inner product result (S45X). Note that the metric tensor obtained in step S42 is based on the angle illustrated in FIG. 15. The conversion from contravariant vector A′ to covariant vector A in step S43X can be performed as in the following Formula 8 using a degree measure for angles, for example.

$$\begin{matrix}[ Formula 8 ] & \\ A = ( \begin{matrix}cos 0 & cos 150 & cos 135 & cos 110 & cos 100 & cos 95 & cos 90 & cos 90 \\ cos 150 & cos 0 & cos 150 & cos 135 & cos 110 & cos 100 & cos 95 & cos 90 \\ cos 135 & cos 150 & cos 0 & cos 150 & cos 135 & cos 110 & cos 100 & cos 95 \\ cos 110 & cos 135 & cos 150 & cos 0 & cos 150 & cos 135 & cos 110 & cos 100 \\ cos 100 & cos 110 & cos 135 & cos 150 & cos 0 & cos 150 & cos 135 & cos 110 \\ cos 95 & cos 100 & cos 110 & cos 135 & cos 150 & cos 0 & cos 150 & cos 135 \\ cos 90 & cos 95 & cos 100 & cos 110 & cos 135 & cos 150 & cos 0 & cos 150 \\ cos 90 & cos 90 & cos 95 & cos 100 & cos 110 & cos 135 & cos 150 & cos 0\end{matrix} ) {A}^{′} & ( 8 )\end{matrix}$$

In step S45X, the reason why the absolute value is obtained for the inner product result calculated in step S44 is that the metric tensor forms an indefinite matrix. That is, since there is a possibility that the inner product result in step S44, that is, the square of the length of the vector becomes negative, it is necessary to take an absolute value.

In processing state estimation apparatus 100, the plurality of difference vectors are contravariant vectors, and the angle between the basis vectors forming the plurality of difference vectors is equal to or larger than 90° and smaller than 180°. According to this configuration, the processing state value can be estimated more accurately than in the related art.

In processing state estimation apparatus 100, the angle between the basis vectors forming the plurality of difference vectors is set to be larger as the time interval is smaller. According to this configuration, in the calculation of the Euclidean distance, weighting can be performed so as to reflect the feature of the processing state, and the processing state value can be estimated more accurately than in the related art.

### (Second Modification)

In the above exemplary embodiment and modification, CPU 1 obtains the similarity based on the waveforms representing the measurement results of load sensor 11 and distance sensor 12. However, the processing state estimation apparatus according to the present disclosure may obtain the similarity based on time instead of the position of punch 73 by distance sensor 12. In the cycle processing by the general press machine 50, the press machine is always controlled to vertically move slide 52 at a constant speed. Therefore, since the press machine controls the speed of the punch 73 so that the speed is constant from one cycle process to another, the waveform width may be represented by elapsed time rather than by punch travel distance. According to this configuration, distance sensor 12 is not necessary, and the processing state can be estimated with a simpler configuration.

### (Third Modification)

In the above exemplary embodiment, an example of estimating the processing state value from the measured waveform of the load applied to the tool has been described. However, the processing state estimation apparatus according to the present disclosure may estimate the processing state value based on, for example, pressure, strain, flow rate, current, voltage, or temperature. According to this configuration, for example, even in a case where a sensor for measuring a load cannot be installed, the processing state value can be estimated. In addition, in injection molding in which cycle processing is performed, by determining a processing waveform from a measured waveform of temperature, a processing state value such as a shape in injection molding can be estimated.

### (Fourth Modification)

In the above exemplary embodiment, an example has been described in which CPU 1 of the processing state estimation apparatus 100 calculates the metric tensor as the preset (S0). However, the metric tensor may be calculated by a CPU or the like of an external information processing apparatus, and the processing state estimation apparatus 100 may acquire data of the metric tensor from the external information processing apparatus via input I/F3, for example.

### (Fifth Modification)

In the above exemplary embodiment, press machine 50 has been described as an example of the processing machine, but the processing machine is not limited thereto, and may be a forming apparatus. The present disclosure is applicable to these processing machines, and can estimate a processing state based on parameters affecting abnormal processing in these processing machines.

### (Aspect Examples)

Hereinafter, aspects of the present disclosure will be exemplified.

### <Aspect 1>

A processing state estimation apparatus including:
a storage; and
a processor,
wherein the storage is configured to store
   a plurality of processing state values defining a processing state of a processing machine, and
   a plurality of pieces of reference data each corresponding to a different one of combinations of the plurality of processing state values,
the processor is configured to
   acquire time-series measurement data measured during processing by the processing machine,
   determine at least one piece of reference data from among the plurality of pieces of reference data,
   determine a plurality of difference vectors based on differences between the time-series measurement data and the at least one piece of reference data at a plurality of measurement points temporally separated from each other,
   determine a Euclidean distance between the time-series measurement data and the at least one piece of reference data in an oblique coordinate system based on the plurality of difference vectors, and
   estimate the processing state based on the determined Euclidean distance,
wherein an angle between basis vectors forming the plurality of difference vectors is set to vary depending on a time interval between the plurality of measurement points.

### <Aspect 2>

The processing state estimation apparatus according to Aspect 1,
wherein the plurality of difference vectors are covariant vectors, and
the angle is larger than 0° and less than or equal to 90°.

### <Aspect 3>

The processing state estimation apparatus according to Aspect 2, wherein the angle is set to be larger as the time interval is larger.

### <Aspect 4>

The processing state estimation apparatus according to any one of Aspects 1 to 3,
wherein the plurality of difference vectors are contravariant vectors, and
the angle is equal to or greater than 90° and less than 180°.

### <Aspect 5>

The processing state estimation apparatus according to Aspect 4, wherein the angle is set to be larger as the time interval is smaller.

### <Aspect 6>

The processing state estimation apparatus according to any one of Aspects 1 to 5,
further including an input unit that receives an input of a user operation for setting the angle,
wherein the processor sets the angle based on the input of the user operation.

### <Aspect 7>

A processing state estimation method including:
acquiring time-series measurement data measured during processing by the processing machine;
determining at least one piece of reference data from among a plurality of pieces of reference data, each of which corresponds to a different one of combinations of a plurality of processing state values that define a processing state of the processing machine;
determining a plurality of difference vectors based on differences between the time-series measurement data and the at least one piece of reference data at a plurality of measurement points temporally separated from each other;
acquiring setting data relating to an angle formed between basis vectors that constitute the plurality of difference vectors;
determining a Euclidean distance between the time-series measurement data and the at least one piece of reference data in an oblique coordinate system based on the plurality of difference vectors, and
estimating the processing state based on the determined Euclidean distance,
wherein an angle between basis vectors forming the plurality of difference vectors is set to vary depending on a time interval between the plurality of measurement points.

According to the processing state estimation apparatus and the processing state estimation method according to the present disclosure, the processing state of the processing machine can be estimated with higher accuracy than in the related art.

The present disclosure is applicable to a processing machine.

What is claimed is:

1. A processing state estimation apparatus comprising:
a storage; and
a processor,
wherein the storage is configured to store
a plurality of processing state values defining a processing state of a processing machine, and
a plurality of pieces of reference data each corresponding to a different one of combinations of the plurality of processing state values,
the processor is configured to
acquire time-series measurement data measured during processing by the processing machine,
determine at least one piece of reference data from among the plurality of pieces of reference data,
determine a plurality of difference vectors based on differences between the time-series measurement data and the at least one piece of reference data at a plurality of measurement points temporally separated from each other,
determine a Euclidean distance between the time-series measurement data and the at least one piece of reference data in an oblique coordinate system based on the plurality of difference vectors, and
estimate the processing state based on the determined Euclidean distance,
wherein an angle between basis vectors forming the plurality of difference vectors is set to vary depending on a time interval between the plurality of measurement points.

2. The processing state estimation apparatus according to claim 1,
wherein the plurality of difference vectors are covariant vectors, and
the angle is larger than 0° and less than or equal to 90°.

3. The processing state estimation apparatus according to claim 2, wherein the angle is set to be larger as the time interval is larger.

4. The processing state estimation apparatus according to claim 1,
wherein the plurality of difference vectors are contravariant vectors, and
the angle is equal to or greater than 90° and less than 180°.

5. The processing state estimation apparatus according to claim 4, wherein the angle is set to be larger as the time interval becomes smaller.

6. The processing state estimation apparatus according to claim 1,
further comprising an input unit that receives an input of a user operation for setting the angle,
wherein the processor sets the angle based on the input of the user operation.

7. A processing state estimation method comprising:
acquiring time-series measurement data measured during processing by the processing machine;
determining at least one piece of reference data from among a plurality of pieces of reference data, each of which corresponds to a different one of combinations of a plurality of processing state values that define a processing state of the processing machine;
determining a plurality of difference vectors based on differences between the time-series measurement data and the at least one piece of reference data at a plurality of measurement points temporally separated from each other;
acquiring setting data relating to an angle formed between basis vectors that constitute the plurality of difference vectors;
determining a Euclidean distance between the time-series measurement data and the at least one piece of reference data in an oblique coordinate system based on the plurality of difference vectors, and
estimating the processing state based on the determined Euclidean distance,
wherein an angle between basis vectors forming the plurality of difference vectors is set to vary depending on a time interval between the plurality of measurement points.
